(19) United States
(12) Patent Application Publication
(10) Pub. No.: US 2011/0231027 A1
(43) Pub. Date: Sep. 22, 2011

(54) Systems for monitoring power consumption

(75) Inventor: Sang Hun Lee, San Ramon, CA (US)

(73) Assignee: AMARANTE TECHNOLOGIES, INC., Santa Clara, CA (US)

(21) Appl. No.: 13/049,897

(22) Filed: Mar. 17, 2011

Related U.S. Application Data
(63) Continuation-in-part of application No. 12/728,214, filed on Mar. 20, 2010.

(51) Int. Cl. G05D 7/06

(52) U.S. Cl. 700/291

(57) ABSTRACT

Systems for monitoring power consumption. The system includes at least one circuit breaker having a sensor for measuring current flowing through the circuit breaker and for sending a sensor signal commensurate with the current and a first electrical connector connected to the sensor. The system also includes a controller spaced apart from the circuit breaker and adapted to receive the sensor signal from the circuit breaker, a second electrical connector adapted to detachably engage the first electrical connector and connected to the controller, and an external device for communicating an electrical signal with the controller to control the controller.

### CROSS REFERENCE TO RELATED APPLICATIONS

This application is a continuation-in-part of application Ser. No. 12/728,214, entitled “Systems for monitoring power consumption,” filed on Mar. 20, 2010, which is hereby incorporated herein by reference in its entirety.

### BACKGROUND

The present disclosure generally relates to an apparatus for monitoring power consumption, more particularly, to a system including circuit breakers with current sensors and a controller for communicating with the circuit breakers to thereby monitor power consumption.

To effectively manage power generation, government regulators have been looking for a means to match consumption with generation, such as a smart power meter (or, shortly, smart meter). A smart meter is typically deployed between the power line extending from a utility pole and a circuit breaker of customer premises. Unlike traditional electrical meters that can only measure total consumption, provide no information of when the energy was consumed, a smart meter can provide an economical way of measuring this information, allowing price setting agencies to introduce different prices for consumption based on the time of day and the season. For instance, electricity pricing usually peaks at certain predictable times of the day and the season.

Even though an existing smart meter can provide the information of power consumption to the setting agencies, it does not display the same information to the consumer. Also, an existing smart meter can only provide the information of overall power consumption, not the information of power consumption by each electrical appliance in the customer's premises. If the customer is able to access detailed data on his energy use, it would be easier for him to reduce power consumption as well as his electricity bill. Thus, there is a strong need for a system that can provide the customer with detailed information of his electric energy use.

### SUMMARY OF THE DISCLOSURE

In one embodiment, a system for monitoring power consumption includes at least one circuit breaker having a sensor for measuring current flowing through the circuit breaker and for sending a sensor signal commensurate with the current and an electrical connector connected to the sensor.

In another embodiment, a system for monitoring power consumption includes: at least one circuit breaker having a sensor for measuring current flowing through the circuit breaker and for sending a sensor signal commensurate with the current and a first electrical connector connected to the sensor; a controller spaced apart from the circuit breaker and adapted to receive the sensor signal from the circuit breaker; a second electrical connector adapted to detachably engage the first electrical connector and connected to the controller; and an external device for communicating an electrical signal with the controller to control the controller.

### BRIEF DESCRIPTION OF THE DRAWINGS

FIG. 1 shows a schematic diagram of a house having a system for monitoring power use thereof in accordance with one embodiment of the present invention;

FIG. 2 shows a schematic diagram of the system for monitoring power use in FIG. 1;

FIG. 3 shows a schematic circuit diagram of the circuit breaker in FIG. 2;

FIG. 4 shows an enlarged view of the controller in FIG. 2;

FIG. 5a shows a computer screen displaying a graphic image of a user interface that simulates the controller in FIG. 2 in accordance with another embodiment of the present invention;

FIG. 5b shows a controller that might be used with the user interface in FIG. 5b;

FIG. 6 shows an exemplary plot of a signal generated by one of the circuit breakers in FIG. 3;

FIG. 7 shows exemplary plots of power consumption as functions of time;

FIG. 8 shows a schematic circuit diagram of a circuit breaker in accordance with yet another embodiment of the present invention;

FIG. 9 shows a schematic diagram of a controller that might be used with the circuit breaker in FIG. 8;

FIG. 10 shows a schematic diagram of a controller in accordance with still another embodiment of the present invention;

FIG. 11 shows a schematic diagram of a circuit breaker in accordance with still another embodiment of the present invention;

FIG. 12 shows a schematic diagram of a controller in accordance with further another embodiment of the present invention; and

FIG. 13 shows a system environment in accordance with an embodiment of the present invention.

### DETAILED DESCRIPTION OF THE PREFERRED EMBODIMENTS

The following detailed description is of the best currently contemplated modes of carrying out the invention. The description is not to be taken in a limiting sense, but is made merely for the purpose of illustrating the general principles of the invention because the scope of the invention is best defined by the appended claims.

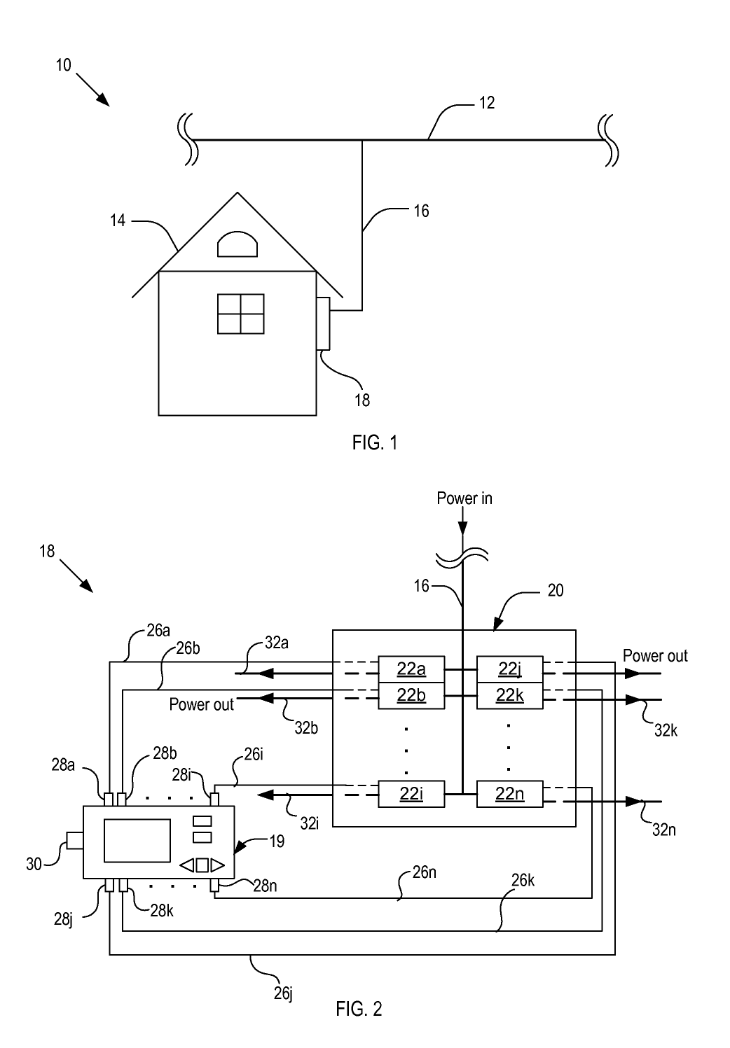

Referring now to FIG. 1, there is shown at 10 a house 14 having a system 18 for monitoring power use thereof in accordance with one embodiment of the present invention. As depicted, the system 18 is connected to a power line 16 that branches off of the power line 12 from a utility pole. The system 18 can monitor, collect, and provide the information of power use of the house 14 to the customer so that the customer may be able to manage his power use more efficiently.

FIG. 2 shows a schematic diagram of the system 18 for monitoring power use of the house 14. As depicted, the system 18 includes: a circuit breaker box 20 having a plurality of circuit breakers 22a-22n; a controller 19 having ports 28a-28n connected to the circuit breakers 22a-22n via lines 26a-26n. Each of the circuit breakers 22a-22n is connected to the power line 16 to receive power therethrough and outputs power through a corresponding one of the lines 32a-32n.

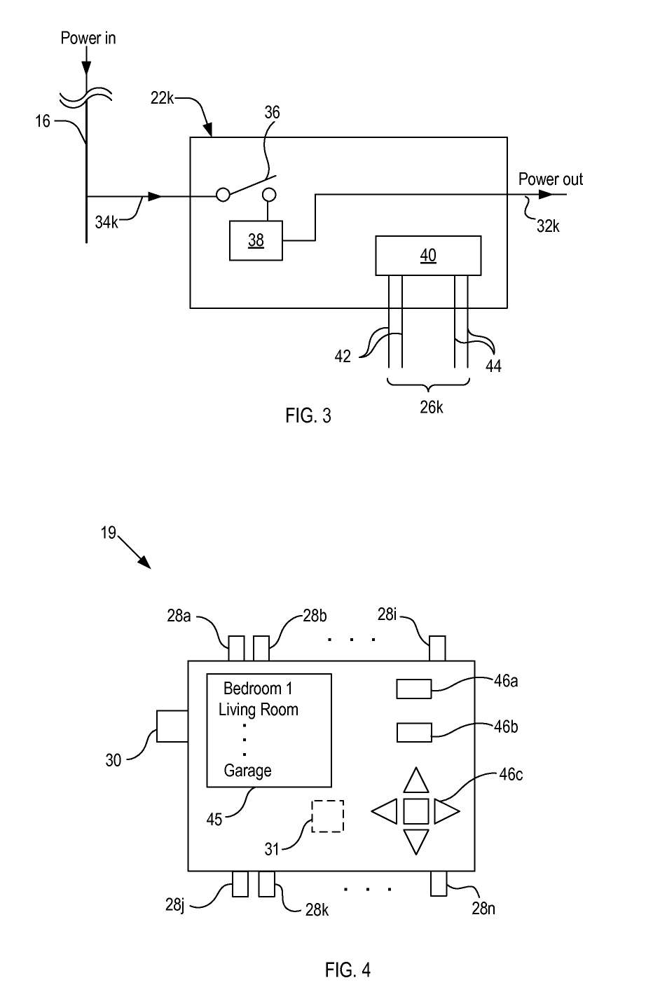

FIG. 3 shows a schematic circuit diagram of one of the circuit breakers, for example 22k, in FIG. 2. As depicted, the circuit breaker 22k may receive power through a power line 34k that is connected to the power line 16 and output power to electrical appliances through a line 32k. The circuit breaker 22k includes: a switch 36; a tripping mechanism 38; and a sensor 40 for measuring the current flowing through the power circuit breaker 22k.

The tripping mechanism 38 may include a solenoid or an electromagnet, for instance, and the current flowing through the circuit breaker 22k magnetizes the tripping mechanism 38 when the switch 36 is closed. However, when the current jumps to unsafe levels, the electromagnetic force generated by the tripping mechanism 38 becomes strong enough to move the moving contact of switch 36 from the stationary contact to break the circuit and to thereby discontinue the current flow. There are other types of circuit breakers. For example, the tripping mechanism 38 may be powered by a separate battery (not shown in FIG. 3). In another example, the circuit breaker 22k may include an internal control power source to provide power to the tripping mechanism 38. The structures of the tripping mechanism 38 and switch 36 may vary substantially depending on the voltage class and rated current.

The circuit breaker 22k includes a sensor 40 for measuring the current flowing through the circuit breaker 22k. The sensor 40 may be powered via two lines 42, and send the measured current value via two lines 44, where the line 26k collectively refers to the lines 42 and 44 and is connected to the port 28k (or, more specifically, to the four pins of the port 28k) of the controller 19. The sensor 40 may include an electromagnetic sensor, for instance. It is noted that the sensor may include a wireless communication device so that it can communicate with the controller 19 that includes a wireless communication device.

FIG. 4 shows an enlarged view of the controller 19 shown in FIG. 2. As depicted, the controller 19 includes ports 28a-28n connected to the circuit breakers 22a-22n via lines 26a-26n and receives signals sent by the circuit breakers through the ports. The received signals may be stored in suitable data storage devices or media, such as memory or hard disk 31 included in the controller 19, or retrieved/transmitted to an external device through another port 30. The port 30 may vary depending on the type of the external device. For instance, the port 30 may be a wireless communication port for exchanging signals with a wireless device, or a USB port for connecting to a computer. It should be apparent to those of ordinary skills in the art that the port 30 may be any other suitable device for communicating signals with another suitable external device. It should be also apparent to those of ordinary skills in the art that the controller 19 may also include a wireless communication device to exchange signals with the sensor 40 which has a wireless communication device.

The controller 19, which can contain a programmable logic circuit, includes a user interface that has a display panel 45 and buttons 46a-46c for allowing the user to operate the controller. For instance, the user may push the button 46c to select a port (or a channel) connected to the circuit breaker for “Bedroom 1,” and the name of the selected channel (i.e., “Bedroom 1”) may be highlighted on the display panel 45. Then, the user may push the buttons 46a or 46b to cause the controller to monitor the current flow in the circuit breaker for Bedroom 1. In FIG. 4, only three buttons 46a-46c are shown for the purpose of illustration. However, it should be apparent to those of ordinary skills in the art that the controller 19 may include other suitable types and number of buttons and display panels to allow a user to operate the controller.

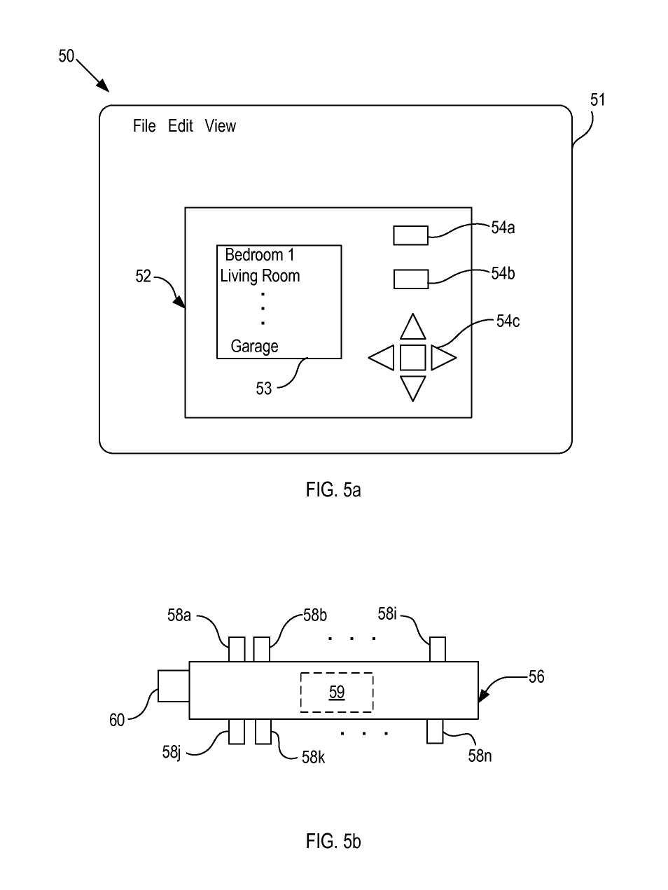

FIG. 5a shows a computer 50 (or, an external device) including a display screen 51 to render a user interface 52 in the form of a graphic image that simulates the controller 19 in accordance with another embodiment of the present invention. In one example, the computer 50 may have a communication port, such as a USB port, that can be connected to the communication port 30 of the controller 19. In another example, the computer 50 may include a wireless communication device that can exchange signals with the controller 19. In yet another example, both the computer 50 and the controller 19 may be connected to the Internet so that the user can remotely control the controller 19. It should be apparent to those of ordinary skills in the art that the computer 50 may include other suitable types of communication devices to allow a user to operate the controller 19 via the user interface 52.

As depicted in FIG. 5a, the user interface 52 may resemble the appearance of the controller 19, and the graphic components 53-54c, when clicked by the user, may actuate the controller 19 as if the user pushed their counterpart buttons 45-46c. It is noted that the user interface 52 may have other suitable types and arrangement of graphic components to provide efficient user interaction. It is also noted that other suitable type of external device that has a graphic display function and a means for communicating signals with the controller 19, such as cell phone or PDA, may be used in place of a computer.

FIG. 5b shows a controller 56 that might be used with the user interface 52 in accordance with another embodiment of the present invention. As depicted, the controller 56 may include: ports 58a-58n to be connected to the circuit breakers; a port 60 for communication with the computer 50 and data storage 59. Since the computer 50 (or external device) has a graphic user interface 52, the controller 56 may not have a graphic display or buttons. It is noted that the controller 19 may be also used with the computer 50 so that the user may have two sets of user interfaces: one on the controller 19 and the other on the computer 50.

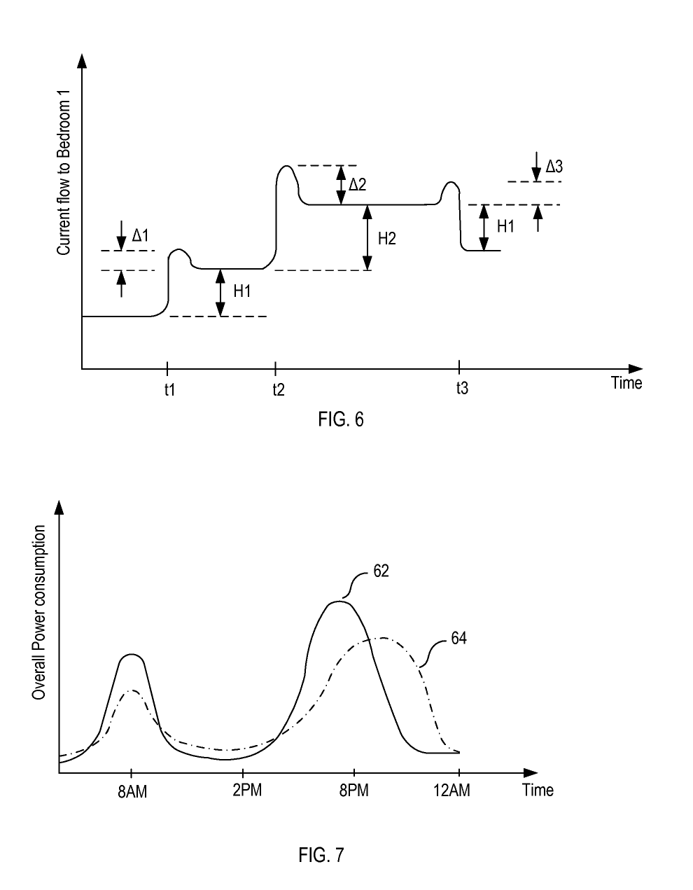

The controller 19 (or 56) may be operated in two modes: training mode and operation mode. During the training mode, the user trains the controller 19 to analyze the signals received from the circuit breakers 22a-22n through the ports 28a-28n and identify the electrical appliances that generate the signals. For instance, the user may actuate the buttons 46a-46c to select one of the circuit breakers, say 28a, that provides power to Bedroom 1. Then, the user causes the controller 19 to monitor the current flowing through the circuit breaker 28a as the user turns on each electrical appliance in Bedroom 1. FIG. 6 shows an exemplary plot of a signal generated and sent by the circuit breaker 28a to the controller 19. When the time is t1, the user may turn on Light 1 in Bedroom 1. The controller 19 may capture some features of the signal, such as an overshoot Δ1, a height H1, and the rising time to the peak of the overshoot Δ1, etc., and store the captured features. When the time is t2, the user may turn on another appliance, say TV in Bedroom 1, to capture the features of the signal when the TV is turned on. By repeating the similar steps for other appliances in the house 14, the user may establish a database that the controller 19 can use to identify an appliance each time the appliance is turned on. Also, the user may repeat the similar steps when each appliance is turned off. For example, when the time is t3, the user turns off the Light 1 in Bedroom 1. The controller 19 may capture some features of the signal, such as an overshoot Δ3, a height H1, and the falling time from the peak of the overshoot Δ3, etc., and store the captured features. Then, based on the captured features, the controller 19 may identify each appliance when the appliance is turned off. Upon completing the data collection, the controller 19 may be switched into the operation mode.

During the operation mode, the controller 19 may continuously monitor signals from the circuit breakers 22a-22n, and store/analyze the monitored signal data as the user planned. For example, the controller 19 may provide the user with the power usage information of a specific appliance, such as a washing machine. In another example, the controller 19 may provide the information of overall power consumption as a function of time. FIG. 7 shows exemplary plots of overall power consumption as functions of time that are generated by the controller 19. Therein, the curve 62 may represent exemplary power consumption as a function of time before the user adjusts his power consumption habits. As depicted, there are two time intervals during which the power consumption reaches peak values. If the power supplying agency charges a lower billing rate for unit power consumption during the non-peak hours, say 11 AM-2 PM and 9 PM-4 AM, the user may adjust his power consumption habits so that certain appliances, such as washing machine, can be operated during the non-peak hours. The curve 64 may represent exemplary power consumption as a function of time after the user adjusts his power consumption habits. As depicted, the user shifts the peak power consumption periods toward the non-peak hours, to thereby be more responsive to market price and reduce the electricity bill.

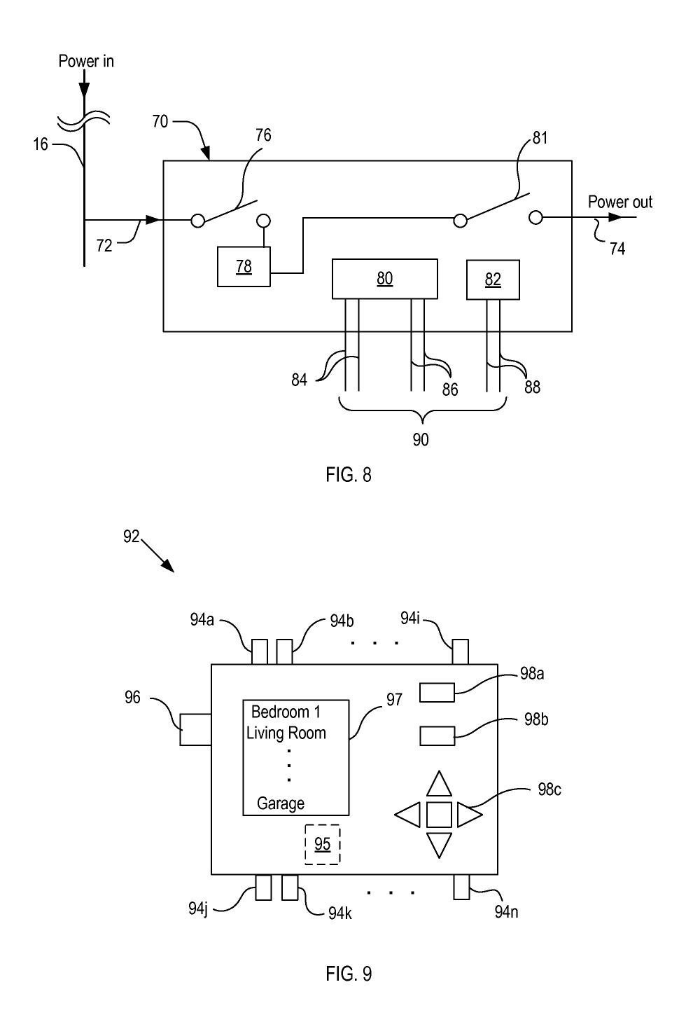

FIG. 8 shows a schematic circuit diagram of a circuit breaker 70 in accordance with another embodiment of the present invention. A plurality of circuit breakers identical to the circuit breaker 70 may be housed in a circuit breaker box (not shown in FIG. 9) similar to the circuit breaker box 20 in FIG. 2. As depicted, the circuit breaker 70 may receive power through a power line 72 that is connected to the power line 16 and output power through a line 74. The circuit breaker 70 includes: a switch 76; a tripping mechanism 78; and a sensor 80 for measuring the current flowing through the power circuit breaker 70. The functions of the switch 76, tripping mechanism 78, sensor 80, and lines 84, 86 may be similar to those of their corresponding components of the circuit breaker 22k (shown in FIG. 3). As such detained description of these components is not repeated for brevity.

The circuit breaker 70 also includes additional switch 81 and tripping mechanism 82. The tripping mechanism 82 is connected to a controller via two lines 88 and, when activated by a signal received through the lines 88, it opens the switch 81 to discontinue the current flowing through the line 74. The tripping mechanism 82 may include a solenoid, for instance, and be powered by a separate battery (not shown in FIG. 8). In another example, the circuit breaker 70 may include an internal control power source to provide power to the tripping mechanism 82. The structure of the tripping mechanism 82 may be changed substantially depending on the voltage class and rated current, insofar as its major function is the same. The circuit breaker 70 may be connected to a port of a controller via the six lines 84, 86, and 88, where the line 90 collectively indicates the six lines.

It is noted that the sensor 80 may include a wireless communication device so that it can exchange signals with a controller having a wireless communication device. The sensor 80 may also receive wireless signals from a controller and activate other components within the circuit breaker 70, such as the tripping mechanism 82.

FIG. 9 shows a schematic diagram of a controller 92 that might be used with the circuit breaker 70. As depicted, the controller 92 includes ports 94a-94n, where each of the ports may be connected to the circuit breaker 70 via the line 90 and exchange signals with the circuit breaker via the line 90. As the line 90 has six electrical lines, each of the port 94a-94n may include at least six pins. The received signals from the circuit breaker 70 via the lines 86 may be stored in suitable data storage devices or media, such as memory or hard disk 95 included in the controller 92, or be retrieved/transmitted to an external device through a port 96. The port 96 may vary depending on the type of the external device. For instance, the port 96 may be a wireless communication port for exchanging signals with a wireless device, or a USB port for connecting to a computer. It should be apparent to those of ordinary skills in the art that the port 96 may be any other suitable type of device which can communicate signals with an external device.

The controller 92 includes a display panel 97 and buttons 98a-98c for allowing the user to actuate the controller, where the display panel 97 and buttons 98a-98c are similar to those of the controller 19. As the number and arrangement of the buttons on the controller 92 may be varied without changing the scope of the present teachings, detailed description of the display panel 97 and buttons 98a-98c is not repeated. The controller 92 may also include a wireless communication device to exchange signals with the sensor 80 having a wireless communication device.

The functions of the controller 92 are similar to those of the controller 19, with a difference that the controller 92 can send a tripping signal to the circuit breaker 70. The tripping signal may be sent by a user via the controller 92, or the user may program the controller to send the signal. For example, based on the data collected by the controller 96, the user may notice that appliances in the garage are not operated during a certain time period of the day. Then, the user may program the controller 92 to send a signal to the tripping mechanism 82 at the onset of the time period so that the switch 81 is open, and to send another signal to reset the switch 81 at the end of the time period. Subsequently, the power to the garage is cut off during the time period, to thereby force the garage lights turned off if the user inadvertently left the lights on. In another example, the controller 92 may be connected to the Internet via the port 96, and the owner of the house 14 may control the power use via the Internet while he is remotely located.

An external device that has a graphical display capability, such as computer, cell phone, or PDA, may be used to render an image of a user interface that simulates the display panel 97 and buttons 98a-98c of the controller 92. As the graphical user interface for simulating the controller 92 would be similar to the graphic image 52 in FIG. 5a, the graphical user interface for the controller 92 is not described for brevity.

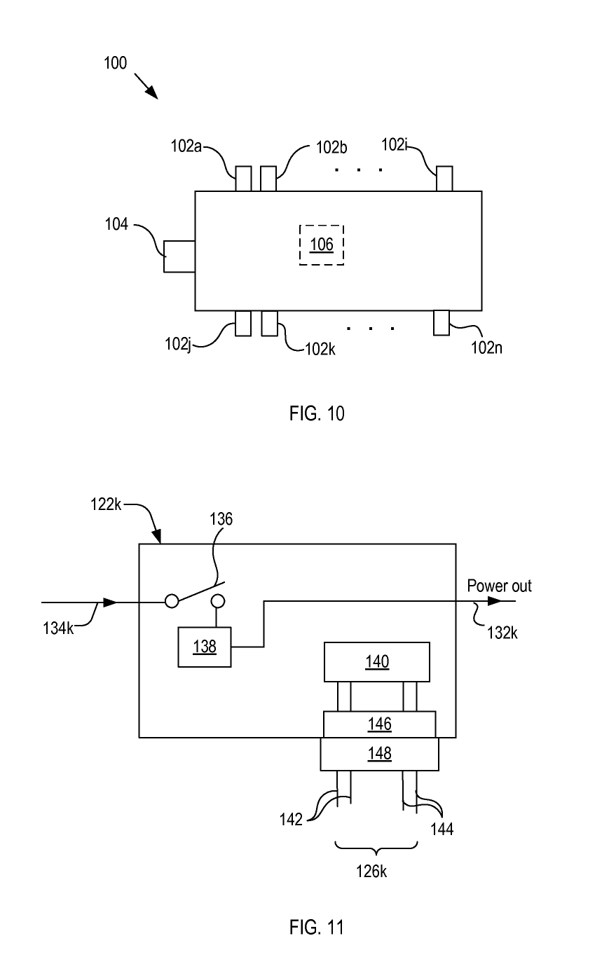

The circuit breaker 70 may be used with an external device that has a graphical display capability. Since the external device can render a graphical user interface, a controller that does not contain a display panel and buttons may be also used with the external device. FIG. 10 shows a schematic diagram of a controller 100 in accordance with still another embodiment of the present invention. As depicted, the controller 100 includes: a plurality of ports 102a-102n to be connected to the circuit breakers 70; optional data storage 106; and a port 104 for communication with an external device that has a graphic display capability. However, as discussed above, the controller 100 does not include any display panel or button since the external device can render a graphical user interface,

It is noted that the plots in FIGS. 6 and 7 are generated using the signals from the controller 19. However, it should be apparent to those of ordinary skill in the art that similar plots can be generated using the signals generated by the controllers 59, 92, and 100.

FIG. 11 shows a schematic diagram of a circuit breaker 122k in accordance with still another embodiment of the present invention. As depicted, the circuit breaker 122k is similar to the circuit breaker 22k in FIG. 3, with the difference that the circuit breaker 122k includes a pair of electrical connectors 146, 148. The circuit breaker 122k may receive power through a power line 134k that is connected to an input power line (such as 16) and output power to electrical appliances through a line 132k. The circuit breaker 122k includes: a switch 136; a tripping mechanism 138; and a sensor 140 for measuring the current flowing through the power circuit breaker 122k. Since the functions and structures of the switch 136, tripping mechanism 138, and sensor 140 are similar to those of their counterparts of the circuit breaker 22k, the detailed description of these elements are not repeated.

The line 126k, which includes lines 142 and 144, are similar to the line 26k (shown in FIG. 3), with the difference that the proximal ends of the lines 142 and 144 are connected to a first electrical connector 148. The first connector 148 is configured to detachably engage the second electrical connector 146, where the second electrical connector 146 is mounted inside the circuit breaker 122k. The circuit breaker box 20 (FIG. 3) may include one or more of circuit breakers that are similar to the circuit breaker 122k. In such a case, the user may detachably connect the first electrical connectors 148 to one of the circuit breakers 122k so that the user may monitor the consumption of power provided through the connected circuit breaker.

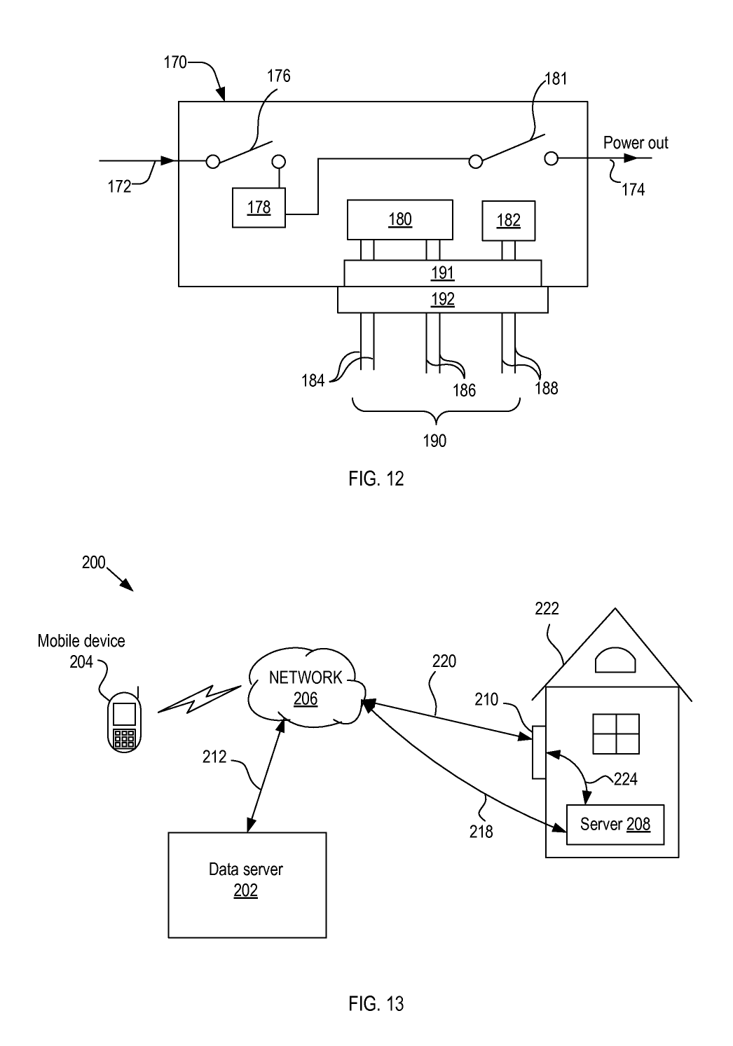

FIG. 12 shows a schematic diagram of a circuit breaker 170 in accordance with further another embodiment of the present invention. As depicted, the circuit breaker 170 is similar to the circuit breaker 70 in FIG. 8, with the difference that the circuit breaker 170 includes a pair of electrical connectors 191, 192. The circuit breaker 170 may receive power through a power line 172 that is connected to an input power line (such as 16) and output power to electrical appliances through a line 174. The circuit breaker 170 includes: a switch 176; a tripping mechanism 178; and a sensor 180. The circuit breaker 170 also includes an additional switch 181 and a tripping mechanism 182. The functions and structures of the components 176, 178, 180, 181, and 182 are similar to their counterparts of the circuit breaker 70, and thus, the detailed description of these elements are not repeated.

The line 190, which includes lines 184, 186, and 188, are similar to the line 90 (shown in FIG. 8), with the difference that the proximal ends of the lines 184, 186, and 188 are connected to a first electrical connector 192. The first connector 192 is configured to detachably engage the second electrical connector 191, where the second electrical connector 191 is mounted inside the circuit breaker 170. The circuit breaker box 20 (FIG. 3) may include one or more of circuit breakers that are similar to the circuit breaker 170. In such a case, the user may detachably connect the second electrical connectors 192 to one of the circuit breakers 170 so that the user may monitor the consumption of power provided through the connected circuit breaker.

FIG. 13 shows a system environment 200 in accordance with an embodiment of the present invention. As depicted, a house 222 may include a system 210 for monitoring power use thereof, where the system 210 is similar to the system 18 (shown in FIG. 2) and includes one or more of the circuit breakers described in FIGS. 2-12. A mobile device 204, which may be carried by a residence of the house 222, may send a signal to the house 222 via a network 206. If a server 208 in the house 222 is capable of analyzing the signal, it will receive the signal via the network 206, as indicated by the arrow 218, analyze the signal and send the analyzed signal to the system 210 via a suitable communication mechanism 224, such as a wireless local network. Alternatively, if the system 210 is capable of analyzing the signal sent by the mobile device 204, the system 210 may receive the signal directly via the network 206, as indicated by an arrow 220.

The signal received, either directly or indirectly via the server 208, by the system 210 may be used to control various electrical appliances in the house 222. For instance, when the signal received by the system 210 indicates that the mobile device 204 is away from the house 222 by a preset distance, the system 210 may turn off the circuit breaker connected to an air conditioner in the house 222, to thereby save power that would be otherwise wasted by the air conditioner.

The signal sent by the mobile device 204 may be received by a data server 202 via the network 206. If the data server 202, which is preferably a computer, is capable of analyzing the signal, it will analyze the signal and send the analyzed signal directly to the system 210 or send the signal to the server 208 which in turn forward the signal to the system 210. Upon receipt of the signal, the system 210 may control the circuit breakers in the system 210.

It should be understood, of course, that the foregoing relates to exemplary embodiments of the invention and that modifications may be made without departing from the spirit and scope of the invention as set forth in the following claims.

What is claimed is:

1. A system for monitoring power consumption, comprising:
at least one circuit breaker including:
a sensor for measuring current flowing through the circuit breaker and sending a sensor signal commensurate with the current; and
a first electrical connector connected to the sensor.

2. A system as recited in claim 1, further comprising:
a controller spaced apart from the circuit breaker and adapted to receive the sensor signal from the circuit breaker; and
a second electrical connector adapted to detachably engage the first electrical connector and connected to the controller.

3. A system as recited in claim 2, wherein the controller includes a user interface that allows a user to control the controller.

4. A system as recited in claim 2, wherein the controller includes at least one port connected to the circuit breaker and the controller is adapted to receive the sensor signal through the port.

5. A system as recited in claim 2, wherein the controller includes data storage for storing the sensor signal received from the circuit breaker.

6. A system as recited in claim 2, wherein the controller is adapted to identify an electrical appliance connected to the circuit breaker based on the sensor signal.

7. A system as recited in claim 2, further comprising:
an external device adapted to communicate an electrical signal with the controller.

8. A system as recited in claim 7, wherein the controller includes a port for communicating with the external device.

9. A system as recited in claim 7, wherein the controller is connected to the external device through Internet.

10. A system as recited in claim 7, wherein the external device includes a display panel for rendering a graphic image that simulates a user interface of the controller.

11. A system as recited in claim 1, wherein the controller includes a programmable logic circuit.

12. A system as recited in claim 3, wherein the circuit breaker includes at least two tripping mechanisms to cut off the current flowing through the circuit breaker, and the controller is adapted to actuate one of the two tripping mechanisms.

13. A system as recited in claim 12, wherein the controller includes at least one port connected to the circuit breaker, and the controller is adapted to receive the sensor signal through the port.

14. A system as recited in claim 12, wherein the controller includes data storage for storing the sensor signal received from the circuit breaker.

15. A system as recited in claim 12, further comprising:
an external device adapted to communicate an electrical signal with the controller.

16. A system as recited in claim 15, wherein the controller includes a port for communicating with the external device.

17. A system as recited in claim 15, wherein the controller is connected to the external device through Internet.

18. A system as recited in claim 15, wherein the external device includes a display panel for rendering a graphic image that simulates a user interface of the controller.

19. A system as recited in claim 15, wherein the external device is a mobile device.

20. A system as recited in claim 19, wherein the electrical signal includes a location information of the mobile device, and the controller controls the at least one circuit breaker in response to the location information.

21. A system for monitoring power consumption, comprising:
at least one circuit breaker including:
a sensor for measuring current flowing through the circuit breaker and sending a sensor signal commensurate with the current; and
a first electrical connector connected to the sensor;
a controller spaced apart from the circuit breaker and adapted to receive the sensor signal from the circuit breaker;
a second electrical connector adapted to detachably engage the first electrical connector and connected to the controller; and
an external device for communicating an electrical signal with the controller to control the controller.

22. A system as recited in claim 21, wherein the circuit breaker includes at least two tripping mechanism to cut off the current flowing through the circuit breaker, and the controller is adapted to actuate one of the two tripping mechanisms.

23. A system as recited in claim 21, wherein the external device includes a display panel for rendering a graphic image that simulates a user interface of the controller.

24. A system as recited in claim 21, wherein the external device is a mobile device.

25. A system as recited in claim 24, wherein the electrical signal includes a location information of the mobile device, and the controller controls the at least one circuit breaker in response to the location information.

26. A system as recited in claim 21, wherein the controller is adapted to identify an electrical appliance connected to the at least one circuit breaker based on the sensor signal.

27. A system for monitoring power consumption, comprising:
at least one circuit breaker including:
a sensor for measuring current flowing through the circuit breaker and sending a sensor signal commensurate with the current; and
a controller spaced apart from the circuit breaker and adapted to receive the sensor signal from the circuit breaker, the controller including a port for communicating an electrical signal with an external device,
wherein the electrical signal includes a location information of the external device and the controller controls the at least one circuit breaker in response to the location information.

28. A system as recited in claim 27, wherein the circuit breaker includes at least two tripping mechanism to cut off the current flowing through the circuit breaker, and the controller is adapted to actuate one of the two tripping mechanisms.

29. A system as recited in claim 27, wherein the external device includes a display panel for rendering a graphic image that simulates a user interface of the controller.

30. A system as recited in claim 27, wherein the external device is a mobile device.
